(19) United States
(12) Patent Application Publication
(10) Pub. No.: US 2003/0168534 A1
(43) Pub. Date: Sep. 11, 2003

(54) Fuel Injection valve

(76) Inventor: Guenther Hohl, Stuttgart (DE)

Correspondence Address: KENYON & KENYON, ONE BROADWAY, NEW YORK, NY, 10004, US

(21) Appl. No.: 10/275,793

(22) PCT Filed: Mar. 14, 2002
(86) PCT No.: PCT/DE02/00909

(30) Foreign Application Priority Data
Mar. 14, 2001 (DE) 101 12 143.1

(51) Int. Cl. B05B 1/30

(52) U.S. Cl. 239/587.1

(57) ABSTRACT

A fuel injector (1), in particular for direct injection of fuel into the combustion chamber of a mixture-compressing, spark-ignited internal combustion engine, includes a valve housing formed by a nozzle body (2), as well as a sealing ring (34), which seals the fuel injector (1) against a cylinder head (42) of the engine.

### BACKGROUND INFORMATION

The present invention is directed to a fuel injector according to the definition of the species in the main claim.

For example, an electromagnetic fuel injector including a suitable mounting structure with which the requirements for the sealing effect, the thermal resistance, and the pressure resistance of an internal combustion engine having a cylinder injection system are met, is known from German Patent Application 196 00 403 A1. Particular attention is paid to the sealing of the area immediately adjacent to the cylinder, in which the electromagnetic fuel injector is mounted, as well as to an area farther away therefrom. According to the present invention, this results in a first sealing sector having a first sealing ring which is designed as a corrugated underlying ring being situated at a point close to the cylinder and between the fuel injector and the cylinder head. Furthermore, a second sealing sector having a second sealing ring, which is also designed as a corrugated underlying ring, is situated at a point which is farther away from the cylinder than the first sealing sector.

Disadvantages of the fuel injector, known from German Patent Application 196 00 403 A1, include the complexity in manufacturing as well as the high manufacturing costs for the sealing rings due to the use of expensive materials such as

Also, complex assembly is always associated with a high sealing effect, which requires great mechanical forces during assembly and may result in damage to the components.

### ADVANTAGES OF THE INVENTION

The fuel injector according to the present invention having the characterizing features of the main claim has the advantage over the related art in that externally the sealing ring has a conical contour, due to which the pressure forces associated with the assembly of the fuel injector having the sealing ring may be reduced. The sealing ring has a radial projection over the nozzle body, and the radial projection increases over the axial length of the sealing ring in the downstream direction.

Advantageous refinements of the fuel injector as recited in the main claim are rendered possible by the measures recited in the subclaims.

It is of particular advantage that the sealing ring has a circumferential groove, which, in connection with a ring formed in a recess, provided for the sealing ring, makes an axial fixation of the sealing ring possible.

A cylindrical recess is advantageously formed at the internal diameter of the sealing ring in the area of the greatest projection Üₘₐₓ, the recess imparting radial elasticity to the sealing ring, thereby reducing the required assembly forces.

A chamfer, formed on both the sealing ring and the cylinder head, is an advantage, because they facilitate the insertion of the fuel injector including the assembled sealing ring into a receiving bore of the cylinder head.

The formation of a gap between the nozzle body and the wall of the receiving bore in the cylinder head advantageously makes a pressure-supported sealing effect during operation of the fuel injector possible.

### DRAWING

An exemplary embodiment of the present invention is illustrated in simplified form in the drawing and is explained in greater detail in the following description.

FIG. 1 shows a schematic section through an exemplary embodiment of a fuel injector according to the present invention in an overall view, and

FIG. 2 shows a schematic detail from the fuel injector designed according to the present invention in area II of FIG. 1.

### DESCRIPTION OF THE EXEMPLARY EMBODIMENT

A fuel injector 1 is designed in the form of a fuel injector for fuel injection systems of mixture-compressing, spark-ignited internal combustion engines. Fuel injector 1 is suitable for direct injection of fuel into a combustion chamber (not shown) of an internal combustion engine.

Fuel injector 1 includes a nozzle body 2, in which a valve needle 3 is situated. Valve needle 3 is mechanically linked to valve-closure member 4, which cooperates with a valve seat surface 6 situated on a valve seat body 5 to form a sealing seat. In the exemplary embodiment, fuel injector 1 represents an inwardly opening fuel injector 1 which has a spray-discharge orifice 7.

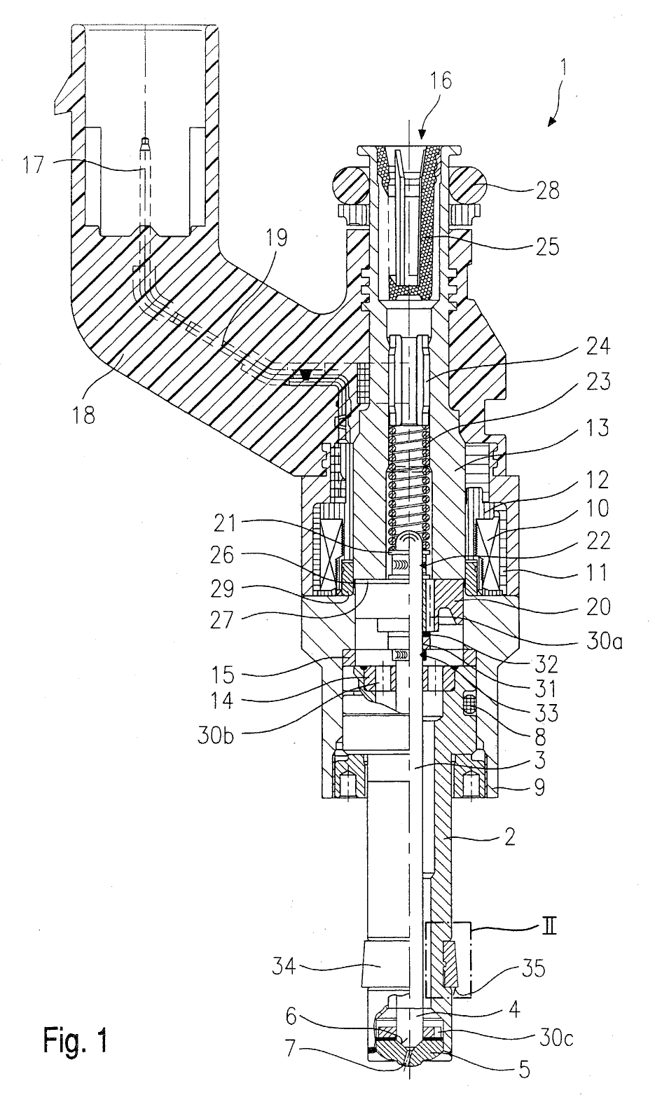

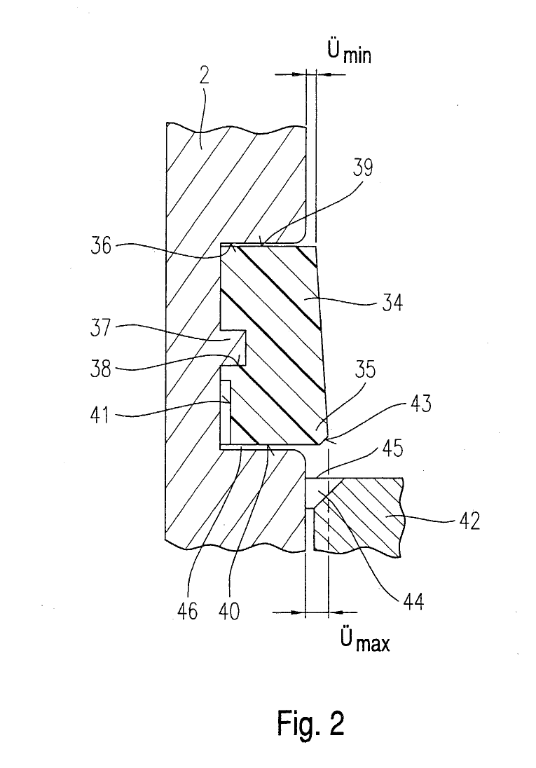

Nozzle body 2 is sealed by a seal 8 against an external pole 9 of a solenoid 10, as well as by a seal 34 against the cylinder head of the engine, not further illustrated in FIG. 1. In order to achieve a reliable sealing effect, sealing ring 34 is made of a material preferably coated with Teflon®, or is directly made of PTFE (Polytetrafluoroethylene). According to the present invention, sealing ring 34 has a conically contoured diameter, whereby projection 35 of sealing ring 34, rising above nozzle body 2, varies over its axial length. A detailed illustration of sealing ring 34 may be obtained from the description regarding FIG. 2.

Solenoid 10 is encapsulated in a coil housing 11 and wound on a field spool 12 which rests on an internal pole 13 of solenoid 10. Internal pole 13 and external pole 9 are separated from one another by a gap 26 and are supported by a connecting part 29. Solenoid 10 is excited by an electric current which is suppliable via a line 19 and an electric plug connection 17. Plug connection 17 is surrounded by a plastic sheathing 18, which may be extruded onto internal pole 13.

Valve needle 3 is guided in a disk-shaped valve needle guide 14. A matching adjusting disk 15 is used to adjust the valve lift. On the other side of adjusting disk 15 there is an armature 20, which is friction-locked via a first flange 21 to valve needle 3, which is connected to first flange 21 by a weld 22. A restoring spring 23 is supported by first flange 21; in the present design of fuel injector 1, restoring spring 23 is pre-stressed by a sleeve 24.

A second flange 31 which serves as the lower armature stop is situated downstream from armature 20. The second flange is friction-locked to valve needle 3 by a weld 33. For damping the rebound of the anchor during closing of fuel injector 1, an elastic intermediate ring 32 is situated between armature 20 and second flange 31.

Fuel channels 30a through 30c run in valve needle guide 14, armature 20, and on valve seat body 5. The fuel is supplied via a central fuel supply line 16 and is filtered through a filter element 25. Fuel injector 1 is sealed against a distribution line (not shown) by a seal 28.

In the resting state of fuel injector 1, first flange 21 at valve needle 3 is acted upon by restoring spring 23 against its lift direction in such a manner that valve-closure member 4 is held on valve seat 6 in a sealing contact. Armature 20 rests on intermediate ring 32 which is supported by second flange 31. When solenoid 10 is excited, it builds up a magnetic field, which moves armature 20 against the elastic force of restoring spring 23 in the lift direction. Armature 20 entrains first flange 21, which is welded to valve needle 3, and thus also valve needle 3 in the lift direction. Valve-closure member 4, which is mechanically linked to valve needle 3, lifts from valve seat surface 6, whereby the fuel, fed to spray-discharge orifice 7 via fuel channels 30a through 30c, is spray-discharged.

If the solenoid current is switched off, after the magnetic field has sufficiently decayed, armature 20 drops off internal pole 13 due to the pressure of restoring spring 23 on first flange 21, whereby valve needle 3 moves against the lift direction. This causes valve-closure member 4 to come to rest on valve seat surface 6 and fuel injector 1 is closed. Armature 20 comes to rest on the armature stop formed by second flange 31.

FIG. 2 shows a partial section of the detail denoted with II in FIG. 1 of fuel injector 1 designed according to the present invention. Identical components are provided with identical reference symbols.

Sealing ring 34 is situated in a groove-shaped circumferential recess 36 of nozzle body 2. To safeguard against shifting during assembly of fuel injector 1 as well as during operation, a ring 37 is provided, which is formed in recess 36 of nozzle body 2, extends beyond the groove base, and engages in a corresponding groove 38 of sealing ring 34.

According to the present invention, sealing ring 34 is conically contoured. This means, as already mentioned, that projection 35, rising radially over nozzle body 2, varies over the axial length of sealing ring 34. Projection 35 is minimal at an upstream front face 39 of sealing ring 34, while projection 35 is maximal at a downstream front face 40 of sealing ring 34. This is denoted in FIG. 2 with Üₘₐₓ, and Üₘₐₓ.

Furthermore, sealing ring 34 is provided with a cylindrical recess 41 downstream from ring 37, whereby sealing ring 34 is situated in this area at a distance from the groove base of recess 36, so that recess 36 imparts a slight elasticity to sealing ring 34. This is advantageous for the assembly of sealing ring 34 in recess 36 of nozzle body 2, because the diameter of sealing ring 34 is enlarged in this area, and thus the force necessary for sliding sealing ring 34 onto nozzle body 2 is smaller. The insertion into recess 36 is also simplified.

The radial elasticity is also advantageous for the assembly of fuel injector 1 in a cylinder head 42 of the engine. If fuel injector 1 including sealing ring 34 is inserted into an appropriate receiving bore of cylinder head 42, then sealing ring 34 may be radially compressed due to cylindrical recess 41; thus the area of maximal projection 35 is subsequently compressed. This results in an easy insertability of fuel injector 1 into cylinder head 42.

In addition, the assembly is reinforced by a chamfer 43 on the downstream front face 40 of sealing ring 34 having maximal projection 35, the chamfer rounding off maximal projection 35 in this area. A similar effect may be achieved by an appropriate chamfer 44 at an edge 45 of the receiving bore of cylinder head 42.

The reliable sealing effect of sealing ring 34 designed according to the present invention is possible by the radial pressure exerted on it. The combustion chamber pressure is greater downstream from sealing ring 34 than the ambient pressure on the upstream side of sealing ring 34; sealing ring 34 expands in the radial direction by the combustion chamber pressure via a gap 46 between downstream front face 40 and recess 36, the gap being connected to cylindrical recess 41, so that the sealing effect is reinforced during operation of fuel injector 1.

The present invention is not limited to the exemplary embodiment illustrated and is applicable to other cross section shapes of sealing rings 34, as well as to any design of fuel injectors 1, for example for fuel injectors 1 connected to a common rail system.

What is claimed is:

1. A fuel injector (1) for direct injection of fuel, in particular into the combustion chamber of a mixture-compressing, spark-ignited internal combustion engine, having a valve housing formed by a nozzle body (2), and a sealing ring (34) which seals the fuel injector (1) against a cylinder head (42) of the internal combustion engine,
wherein the sealing ring (34) is conically contoured on the outside, the external radius of the sealing ring (34) and a projection (35) of the sealing ring (34), protruding over the nozzle body (2), increasing in a downstream direction.

2. The fuel injector (1) as recited in claim 1,
wherein the projection (35) is minimal on an upstream front face (39) of the sealing ring (34) and maximal at a downstream front face (40) of the sealing ring (34).

3. The fuel injector as recited in claim 1 or 2,
wherein the sealing ring (34) is partially situated in a recess (36) of the nozzle body (34).

4. The fuel injector as recited in claim 3,
wherein a protruding ring (37) is formed in the recess (36), the protruding ring engaging in a groove (38) of the sealing ring (34) in such a manner that the sealing ring (34) is secured in the axial direction.

5. The fuel injector as recited in claim 4,
wherein the sealing ring (34) has a cylindrical recess (41) on its radial internal diameter downstream from groove (38).

6. The fuel injector as recited in claim 5,
wherein the sealing ring (34) is at a distance from the recess (36) of the nozzle body (2) in the area of the cylindrical recess (41).

7. The fuel injector as recited in claim 2,
wherein the sealing ring (34) has a chamfer (43) in the area of the maximal projection (Üₘₐₓ)

8. The fuel injector as recited in one of claims 1 through 7,
wherein a cylinder head (42) of the internal combustion engine has a chamfer (44) in the area of an edge (45) of a receiving bore for the fuel injector (1).

9. The fuel injector as recited in claim 5 or 6,
wherein a gap (46) is formed between a downstream front face (40) and the recess (36), the gap being connected to the cylindrical recess (41).

10. The fuel injector as recited in claim 9,
wherein the sealing ring (34) may be acted upon by a combustion chamber pressure via the gap (46) and the cylindrical recess (41).
